(19) United States
(12) Patent Application Publication
(10) Pub. No.: US 2026/0035512 A1
(43) Pub. Date: Feb. 5, 2026

(54) POLYAMIDES AND CORRESPONDING POLYMER COMPOSITIONS, ARTICLES AND METHODS FOR MAKING AND USING

(71) Applicant: SYENSQO SPECIALTY POLYMERS USA, LLC, Alpharetta, GA (US)

(72) Inventors: Stéphane Jeol, Saint-Genis-laval (FR); Joel Flores, Alpharetta, GA (US)

(73) Assignee: SYENSQO SPECIALTY POLYMERS USA, LLC, Alpharetta, GA (US)

(21) Appl. No.: 19/354,345

(22) Filed: Oct. 9, 2025

Related U.S. Application Data
(62) Division of application No. 17/635,784, now Pat. No. 12,473,402.
(60) Provisional application No. 62/892,042, filed on Aug. 27, 2019.

(51) Int. Cl. C08G 69/36; C08J 5/04; C08K 7/14

(52) U.S. Cl. CPC C08G 69/36; C08J 5/043; C08K 7/14; C08J 2333/24

(57) ABSTRACT

Described herein are polyamides (PA) incorporating a cycloaliphatic monomer containing a cyclohexyl group. It was surprisingly discovered that by incorporating the cycloaliphatic monomer containing a cyclohexyl group, the resulting polyamides (PA) had significantly reduced water absorption, while maintaining good mechanical properties, relative to both analogous polyamides free of the cycloaliphatic monomer as well as relative to both PA6,T based polyamides copolymerized with either or both of isophthalic acid and adipic acid.

### CROSS REFERENCE TO RELATED APPLICATIONS

This application claims priority to U.S. provisional patent application No. 62/892,042, filed on 27 Aug. 2019, the whole content of this application being incorporated herein by reference for all purposes.

### FIELD OF THE INVENTION

The invention relates to polyamides having improved water absorption properties and good mechanical properties. The invention further relates to polymer compositions including the polyamides. The invention also relates to articles comprising such polymers and polymer compositions.

### BACKGROUND OF THE INVENTION

Polyamides such as PA6,T are generally polymerized with comonomers such as isophthalic acid or adipic acid. Such polyamides have the outstanding mechanical performance and chemical resistance of PA6,T, but can be processed at lower temperatures due to the presence of the comonomers. However, the incorporation of isophthalic acid or adipic acid into PA6 results in a polyamide that has increased moisture absorption, which reduces the dimensional stability of the articles formed from such polymers. Accordingly, there is a need for polyamides having the excellent mechanical performance and chemical resistance of PA6,T-based copolyamides, while having reduced moisture absorption.

### SUMMARY OF INVENTION

In one aspect, the invention is directed to a polyamide (PA) formed from the polycondensation of a reaction mixture (RM) comprising: a diamine component (A) comprising: 55 mol % to 75 mol % of a C₄ to C₈ aliphatic diamine, 25 mol % to 45 mol % of a C₉ to C₁₂ aliphatic diamine, and 0 mol % to 10 mol % of a cycloaliphatic diamine containing a cyclohexyl group, wherein mol % is relative to the total number of moles of diamines in the diamine component (A); a dicarboxylic acid component (B) comprising: 90 mol % to 100 mol % of terephthalic acid, 0 mol % to 10 mol % of a C₆ to C₁₈ aliphatic dicarboxylic acid or an C₈ to C₁₈ aromatic dicarboxylic acid distinct from terephthalic acid, and 0 mol % to 10 mol % of a cycloaliphatic dicarboxylic acid containing a cyclohexyl group, wherein mol % is relative to the total number of moles of dicarboxylic acids in the dicarboxylic acid component (B); and an amino acid component (C) comprising 0 mol % to 9 mol % of a C₈ to C₁₀ cycloaliphatic amino acid containing a cyclohexyl group, wherein mol % is relative to the total number of moles of dicarboxylic acids in the dicarboxylic acid component (B); and wherein one of the cycloaliphatic diamine, the cycloaliphatic dicarboxylic acid, and the cycloaliphatic amino acid has a concentration of greater than 0.5 mol %. In some embodiments, only one of the cycloaliphatic diamine, the cycloaliphatic dicarboxylic acid, and the cycloaliphatic amino acid has a concentration of greater than 0.5 mol % and the reaction mixture (RM) is free of the other two cycloaliphatic monomers containing a cyclohexyl group. Additional or alternatively, in some embodiments, the reaction mixture (RM) is free of the C₆ to C₁₈ aliphatic dicarboxylic acid or an C₈ to C₁₈ aromatic dicarboxylic acid distinct from terephthalic acid.

In another aspect, the invention is directed to a polymer composition (PC), comprising the polyamide (PA) and at least one component selected from the group consisting of reinforcing agents, tougheners, plasticizers, colorants, pigments, antistatic agents, dyes, lubricants, thermal stabilizers, light stabilizers, flame retardants, halogen free flame retardants, nucleating agents and antioxidants, preferably at least a halogen free flame retardant. In some embodiments, the polymer composition (PC) includes 10 wt. % to 60 wt. % of glass fibers, based on the total weight of the polymer composition (PC). In some embodiments, the polymer composition (PC) includes from 30 wt. % to 70 wt. % of the polyamide (PA).

### DETAILED DESCRIPTION OF THE INVENTION

Described herein are polyamides (PA) incorporating a cycloaliphatic monomer containing a cyclohexyl group. It was surprisingly discovered that by incorporating the cycloaliphatic monomer containing a cyclohexyl group, the resulting polyamides (PA) had significantly reduced water absorption, while maintaining good mechanical properties, relative to both analogous polyamides free of the cycloaliphatic monomer as well as relative to both PA6, T-based polyamides copolymerized with either or both of isophthalic acid and adipic acid. Furthermore, it was surprisingly discovered that at relatively low concentrations of the cyclocaliphatic monomer containing a cyclohexyl group, the polyamides (PA) had significantly increased glass transition temperatures (“Tg”), while maintaining high melting temperatures (“Tm”) and crystallization temperatures (“Tc”), relative to analogous polyamides free of the cycloaliphatic monomer.

The polyamides (PA) are formed from the polycondensation of a reaction mixture (RM), as described in detail below, including a cycloaliphatic monomer containing a cyclohexyl group, which is selected from the group consisting of a cycloaliphatic diamine containing a cyclohexyl group, a cycloaliphatic dicarboxylic acid containing a cyclohexyl group, a C₈ to C₁₀ cycloaliphatic amino acid containing a cyclohexyl group. Of course in some embodiments, the reaction mixture (RM) can include two or more distinct cycloaliphatic monomers containing a cyclohexyl group, where each monomer is independently selected from a cycloaliphatic diamine containing a cyclohexyl group, a cycloaliphatic dicarboxylic acid containing a cyclohexyl group, a C₈ to C₁₀ cycloaliphatic amino acid containing a cyclohexyl group.

Unless specifically limited otherwise, the term “alkyl”, as well as derivative terms such as “alkoxy”, “acyl” and “alkylthio”, as used herein, include within their scope linear chain, branched chain and cyclic moieties. Examples of alkyl groups are methyl, ethyl, 1-methylethyl, propyl, 1,1-dimethylethyl, and cyclo-propyl. Unless specifically stated otherwise, each alkyl and aryl group may be unsubstituted or substituted with one or more substituents selected from but not limited to halogen, hydroxy, sulfo, C₁-C₆ alkoxy, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied. The term “halogen” or “halo” includes fluorine, chlorine, bromine and iodine, with fluorine being preferred.

The term “aryl” refers to a phenyl, indanyl or naphthyl group. The aryl group may comprise one or more alkyl groups, and are called sometimes in this case “alkylaryl”; for example may be composed of an aromatic group and two C₁-C₆ groups (e.g. methyl or ethyl). The aryl group may also comprise one or more heteroatoms, e.g. N, O or S, and are called sometimes in this case “heteroaryl” group; these heteroaromatic rings may be fused to other aromatic systems. Such heteroaromatic rings include, but are not limited to furanyl, thienyl, pyrrolyl, pyrazolyl, imidazolyl, triazolyl, isoxazolyl, oxazolyl, thiazolyl, isothiazolyl, pyridyl, pyridazyl, pyrimidyl, pyrazinyl and triazinyl ring structures. The aryl or heteroaryl substituents may be unsubstituted or substituted with one or more substituents selected from but not limited to halogen, hydroxy, C₁-C₆ alkoxy, sulfo, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied.

### The Reaction Mixture

The polyamide (PA) is formed from the polycondensation of a reaction mixture (RM) including a diamine component (A), a dicarboxylic acid component (B), and an amino acid component (C). The diamine component (A) includes 55 mol % to 75 mol % of a C₄ to C₈ aliphatic diamine; 25 mol % to 45 mol % of a C₉ to C₁₂ aliphatic diamine; and 0 mol % to 10 mol % of a cycloaliphatic diamine containing a cyclohexyl group, wherein mol % is relative to the total number of moles of diamines in the diamine component (A). The dicarboxylic acid component (B) includes 90 mol % to 100 mol % of terephthalic acid; 0 mol % to 10 mol % of a C₆ to C₁₈ aliphatic dicarboxylic acid or a C₈ to C₁₈ aromatic dicarboxylic acid distinct from terephthalic acid; and 0 mol % to 10 mol % of a cycloaliphatic dicarboxylic acid containing a cyclohexyl group, wherein mol % is relative to the total number of moles of dicarboxylic acids in the dicarboxylic acid component (B). The amino acid component (C) includes 0 mol % to 9 mol % of a C₈ to C₁₀ cycloaliphatic amino acid containing a cyclohexyl group, wherein mol % is relative to the total number of moles of dicarboxylic acid component (B). For clarity, the C₄ to C₈ aliphatic diamine and the C₉ to C₁₂ aliphatic diamine can be linear or branched aliphatic diamines. Preferably, the C₄ to C₈ aliphatic diamine and the C₉ to C₁₂ aliphatic diamines are both linear aliphatic diamines. Similarly, the C₆ to C₁₈ aliphatic dicarboxylic acid can be a linear or branched aliphatic dicarboxylic acid. In the reaction mixture (RM), preferably, the total concentration of diamines, dicarboxylic acids and amino acids is selected such that [—NH₂]/[—COOH] is from 0.9 to 1.1, preferably from 0.95 to 1.05, where [—NH₂] and [—COOH] are the number of moles of —NH₂ and —COOH groups, respectively, in the reaction mixture (RM).

For ease of reference, as used hereafter, the concentration of a diamine refers to its concentration relative to the total number of moles of diamines in the diamine component (A), unless explicitly noted otherwise. Similarly, as used herein, the concentration of a dicarboxylic acid refers to its concentration relative to the total number of moles of the dicarboxylic acids in the dicarboxylic acid component (B). Additionally, as used herein, the concentration of an amino acid refers to its concentration relative to the total number of moles of dicarboxylic acid component (B). As used herein, “free of” with respect to a monomer in the reaction mixture (RM) means the indicated monomer has a concentration of less than 0.5 wt. %, preferably less than 0.1 wt. % in the corresponding component. For example, if the reaction mixture (RM) is free of the cycloaliphatic diamine containing a cyclohexyl group, it's concentration in the diamine component (A) is less than 0.5 wt. %, preferably less than 0.1 wt. %.

Significantly, as noted above, one of the cycloaliphatic diamine containing a cyclohexyl group, the cycloaliphatic dicarboxylic acid containing a cyclohexyl group, and the C₈ to C₁₀ cycloaliphatic amino acid containing a cyclohexyl group has a concentration of greater than 0.5 mol %. Of course, in some embodiments, any two or all of the cycloaliphatic monomers containing a cyclohexyl group can have a concentration greater than 0.5 mol %. In some embodiments, only one of the three cycloaliphatic monomers containing a cyclohexyl group has a concentration of greater 0.5 mol %, and the reaction mixture (RM) is of the other two cycloaliphatic monomers containing a cyclohexyl group.

The diamine component (A) includes all diamines in the reaction mixture (RM) that polycondense with a dicarboxylic acid or amino acid in the reaction mixture (RM) to form recurring units of the polyamide (PA). Similarly, the dicarboxylic acid component (B) includes all the dicarboxylic acids in the reaction mixture (RM) that polycondense with a diamine or amino acid in the reaction mixture (RM). Further, the amino acid component (C) includes all of the amino acids in the reaction mixture (RM) that polycondense with a diamines, dicarboxylic acid, or amino acid in the reaction mixture (RM).

In some embodiments, the diamine component (A) includes more than 0.5 mol % to 10 mol %, preferably 1 mol % to 10 mol % of a cycloaliphatic diamine containing a cyclohexyl group. In one such embodiment, the reaction mixture (RM) is free of the C₆ to C₁₈ aliphatic dicarboxylic acid or a C₈ to C₁₈ aromatic dicarboxylic acid distinct from terephthalic acid, the cycloaliphatic dicarboxylic acid containing a cyclohexyl group and the C₈ to C₁₀ cycloaliphatic amino acid containing a cyclohexyl group. Additionally or alternatively, in some embodiments, the reaction mixture (RM) is free of additional diamines, additional dicarboxylic acids and additional amino acids. For clarity, additional monomers refer to monomers not explicitly recited in the reaction mixture (RM) as defined above.

In some embodiments, the dicarboxylic acid component (B) includes more than 0.5 mol % to 10 mol %, preferably 1 mol % to 10 mol % of a cycloaliphatic dicarboxylic acid containing a cyclohexyl group. In one such embodiment, the reaction mixture (RM) is free of the cycloaliphatic diamine containing a cyclohexyl group, the C₆ to C₁₈ aliphatic dicarboxylic acid or an C₈ to C₁₈ aromatic dicarboxylic acid distinct from terephthalic acid, and the C₈ to C₁₀ cycloaliphatic amino acid containing a cyclohexyl group. Additionally or alternatively, in some embodiments, the reaction mixture (RM) is free of additional diamines, additional dicarboxylic acids and additional amino acids.

In some embodiments, the amino acid component (C) includes more than 0.5 mol % to 10 mol %, preferably 1 mol % to 10 mol % of a C₈ to C₁₀ cycloaliphatic aminoacid acid containing a cyclohexyl group. In one such embodiment, the reaction mixture (RM) is free of the cycloaliphatic diamine containing a cyclohexyl group, the C₆ to C₁₈ aliphatic dicarboxylic acid or an C₈ to C₁₈ aromatic dicarboxylic acid distinct from terephthalic acid, and the cycloaliphatic dicarboxylic acid containing a cyclohexyl group. Additionally or alternatively, in some embodiments, the reaction mixture (RM) is free of additional diamines, additional dicarboxylic acids and additional amino acids.

### The Diamine Component (A)

The diamine component (A) includes 55 mol % to 75 mol % of a C₄ to C₈ aliphatic diamine, 25 mol % to 45 mol % of a C₉ to C₁₂ aliphatic diamine and 0 mol % to 10 mol % of a cycloaliphatic diamine containing a cyclohexyl group.

In some embodiments, the C₄ to C₈ aliphatic diamine and the C₉ to C₁₂ diamine are represented by the following formulae, respectively:

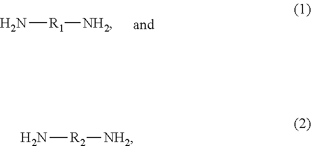

where R₁ is a C₄ to C₈ aliphatic alkyl, preferably a C₆ aliphatic alkyl group, and R₂ is a C₉ to C₁₂ aliphatic alkyl group, preferably a C₁₀ aliphatic alkyl group. In some embodiments, the C₄ to C₈ aliphatic diamine is selected from the group consisting of 1,4-diaminobutane (“putrescine”), 1,5-diaminopentane (“cadaverine”), 2-methyl-1,5-diaminopentane, hexamethylenediamine (“HMDA”), 3-methylhexamethylenediamine, 2,5-dimethylhexamethylenediamine, 1,7-diaminoheptane and 1,8-diaminooctane. In some embodiments, the C₉ to C₁₂ aliphatic diamine is selected from the group consisting of 2,2,4-trimethyl-hexamethylenediamine, 2,4,4-trimethyl-hexamethylenediamine, 2-ethyl-1,7-diaminoheptane, 2-methyl-1,8-diaminooctane, 2,2,7,7-tetramethyloctamethylenediamine, 1,9-diaminononane, 2-methyl-1,8-diaminooctane, 5-methyl-1,9-diaminononane, 1,10-diaminodecane, 1,11-diaminoundecane, and 1,12-diaminododecane. Preferably, the C₄ to C₈ aliphatic diamine is HMDA. Preferably, the C₉ to C₁₂ aliphatic diamine is 1,10-diaminodecane. Most preferably, the C₄ to C₈ aliphatic diamine is HMDA and the C₉ to C₁₂ aliphatic diamine is 1,10-diaminodecane.

In some embodiments, the cycloaliphatic diamine containing a cyclohexyl group is represented by one of the following formulae:

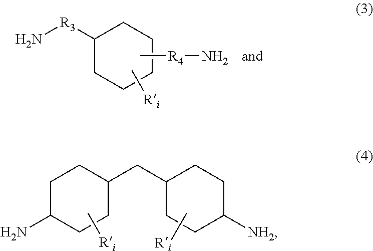

where R₃ and R₄, are independently selected from the group consisting of a bond and a C₁ to C₁₀ alkyl groups; R′, at each location, is independently selected from the group consisting of an alkyl, an aryl, an alkali or alkaline earth metal sulfonate, an alkyl sulfonate, and a quaternary ammonium; and each i is an independently selected integer from 0 to 10. In Formula (3), preferably, the —R₃—NH₂ and —R₄—NH₂ groups are relatively positioned in the meta position (1,3-) or the para position (1,4-), most preferably in the meta position. In some embodiments, the cycloaliphatic diamine containing a cyclohexyl group is selected from the group consisting of isophorone diamine, 1,3-diaminocyclohexane, 1,4-diaminocyclohexane, bis-p-aminocyclohexylmethane, 1,3-bis(aminomethyl) cyclohexane (“1,3-BAC”), 1,4 bis(aminomethyl) cyclohexane (“1,4-BAC”), bis(4-amino-3-methylcyclohexyl) methane and bis(4-aminocyclohexyl) methane. Preferably, the cycloaliphatic diamine containing a cyclohexyl group is 1,3-BAC or 1,4-BAC, most preferably, 1,3-BAC. Of course, the cycloaliphatic diamines containing a cyclohexyl group according to Formula (3) (e.g. 1,3-BAC and 1,4-BAC) can be in a cis or trans conformation. Accordingly, the diamine component (A) can include only the cis isomers, only the trans isomers or a mixture of the cis and the trans isomers.

In some embodiments, the concentration of the C₄ to C₈ aliphatic diamine is from 60 mol % to 70 mol %. In some embodiments, the concentration of the C₉ to C₁₂ aliphatic diamine is from 30 mol % to 45 mol %, preferably from 25 mol % to 38 mol %, most preferably from 30 mol % to 38 mol %. In some embodiments, the concentration of the cycloaliphatic diamine containing a cyclohexyl group is from 1 mol % to 10 mol %, preferably from 3 mol % to 10 mol %. In some embodiments, the reaction mixture (RM) is free of the cycloaliphatic diamine containing a cyclohexyl group.

In some embodiments, the total concentration of the C₄ to C₈ aliphatic diamine, the C₉ to C₁₂ aliphatic diamine and the cycloaliphatic diamine containing a cyclohexyl group is at least 90 mol %, at least 95 mol %, at least 98 mol %, at least 99 mol %, at least 99.5 mol % or at least 99.9 mol %. In some embodiments, the diamine component (A) can include additional diamines, each distinct from each other and from the C₄ to C₈ aliphatic diamine, the C₉ to C₁₂ aliphatic diamine and the cycloaliphatic diamine containing a cyclohexyl group. In some such embodiments including additional diamines, the total concentration of C₄ to C₈ aliphatic diamines, C₉ to C₁₂ aliphatic diamines; and cycloaliphatic diamines containing a cyclohexyl group are all within the corresponding ranges given above. In other such embodiments including additional diamines, the concentration of each additional diamine is distinct from the ranges given above with respect to the C₄ to C₈ aliphatic diamines, the C₉ to C₁₂ aliphatic diamines; and cycloaliphatic diamines containing a cyclohexyl group.

### The Dicarboxylic Acid Component (B)

The dicarboxylic acid component (B) includes 90 mol % to 100 mol % of terephthalic acid; 0 mol % to 10 mol % of a C₆ to C₁₈ aliphatic dicarboxylic acid or an C₈ to C₁₈ aromatic dicarboxylic acid distinct from terephthalic acid; and 0 mol % to 10 mol % of a cycloaliphatic dicarboxylic acid containing a cyclohexyl group,

In some embodiments, the C₆ to C₁₈ aliphatic dicarboxylic acid is selected from the group consisting of 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂—CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecanedioic acid [HOOC—(CH₂)₁₀—COOH], tridecanedioic acid [HOOC—(CH₂)₁₁—COOH], tetradecanedioic acid [HOOC—(CH₂)₁₂—COOH], pentadecanedioic acid [HOOC—(CH₂)₁₃—COOH], hexadecanedioic acid [HOOC—(CH₂)₁₄—COOH], and octadecanedioic acid [HOOC—(CH₂)₁₆—COOH]. Preferably, the C₆ to C₁₈ aliphatic dicarboxylic acid is adipic acid or sebacic acid, most preferably adipic acid.

In some embodiments, the C₈ to C₁₈ aromatic dicarboxylic acid distinct from terephthalic acid is selected from the group consisting of phthalic acids, including isophthalic acid (“IA”) and excluding terephthalic acid (“TA”), naphthalenedicarboxylic acids (e.g. naphthalene-2,6-dicarboxylic acid), 4,4′-bibenzoic acid, 2,5-pyridinedicarboxylic acid, 2,4-pyridinedicarboxylic acid, 3,5-pyridinedicarboxylic acid, 2,2-bis(4-carboxyphenyl) propane, 2,2-bis(4-carboxyphenyl) hexafluoropropane, 2,2-bis(4-carboxyphenyl) ketone, 4,4′-bis(4-carboxyphenyl) sulfone, 2,2-bis(3-carboxyphenyl) propane, 2,2-bis(3-carboxyphenyl) hexafluoropropane, 2,2-bis(3-carboxyphenyl) ketone, bis(3-carboxyphenoxy)benzene. Preferably, the C₈ to C₁₈ aromatic dicarboxylic acid is naphthalenedicarboxylic acid or 4,4′-bibenzoic acid.

In some embodiments, the cycloaliphatic dicarboxylic acid containing a cyclohexyl group is represented by the following formula:

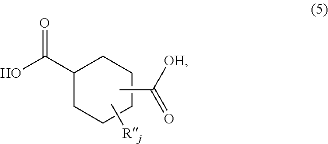

where R″, at each location, is independently selected from the group consisting of an alkyl, an aryl, an alkali or alkaline earth metal sulfonate, an alkyl sulfonate, and a quaternary ammonium; and j is an integer from 0 to 10. In Formula (5), preferably, the —C—COOH groups are relatively positioned in the meta position (1,3-) or the para position (1,4-), most preferably in the para position. In some embodiments, the cycloaliphatic carboxylic acid containing a cyclohexyl group is a cyclohexane dicarboxylic acid (“CHDA”), preferably 1,3-CHDA or 1,4-CHDA, most preferably 1,4-CHDA.

In some embodiments, the concentration of the terephthalic acid is from 92 mol % to 100 mol %, preferably 93 mol % to 100 mol %. In some embodiments, the concentration of the C₆ to C₁₈ aliphatic dicarboxylic acid or the C₈ to C₁₈ aromatic dicarboxylic acid distinct from terephthalic acid is 0 mol % to 0.5 mol %, preferably from 0 mol % to 0.1 mol %. In some embodiments, the concentration of the cycloaliphatic dicarboxylic acid containing a cyclohexyl group is from 3 mol % to 9 mol %. In some embodiments, the dicarboxylic acid component (B) is free one or both of (i) the C₆ to C₁₈ aliphatic linear and the branched dicarboxylic acid or C₈ to C₁₈ aromatic dicarboxylic acid distinct from terephthalic and (ii) the cycloaliphatic dicarboxylic acid containing a cyclohexyl group.

In some embodiments, the total concentration of the terephthalic acid, the C₆ to C₁₈ aliphatic dicarboxylic acid or a C₈ to C₁₈ aromatic dicarboxylic acid distinct from terephthalic acid, and the cycloaliphatic dicarboxylic acid containing a cyclohexyl group is at least 90 mol %, at least 95 mol %, at least 98 mol %, at least 99 mol %, at least 99.5 mol % or at least 99.9 mol %. In some embodiments, the dicarboxylic acid component (B) can include additional dicarboxylic acids, each distinct from each other and from the terephthalic acid, the C₆ to C₁₈ aliphatic dicarboxylic acid or a C₈ to C₁₈ aromatic dicarboxylic acid distinct from terephthalic acid, and the cycloaliphatic dicarboxylic acid containing a cyclohexyl group. In some such embodiments including additional dicarboxylic acids, the total concentration of C₆ to C₁₈ aliphatic dicarboxylic acid or C₈ to C₁₈ aromatic dicarboxylic acids distinct from terephthalic acid and the total concentration the cycloaliphatic dicarboxylic acids containing a cyclohexyl group are within the corresponding ranges given above. In other such embodiments including additional dicarboxylic acids, the concentration of each additional dicarboxylic acid is distinct from the ranges given above with respect to the C₆ to C₁₈ aliphatic dicarboxylic acid or the C₈ to C₁₈ aromatic dicarboxylic acid distinct from terephthalic acid and the cycloaliphatic dicarboxylic acid containing a cyclohexyl group.

### The Amino Acid Component (C)

The amino acid component (C) includes 0 mol % to 9 mol % of a C₈ to C₁₀ cycloaliphatic amino acid containing a cyclohexyl group.

In some embodiments, the C₈ to C₁₀ cycloaliphatic amino acid containing a cyclohexyl group is represented by the following formula:

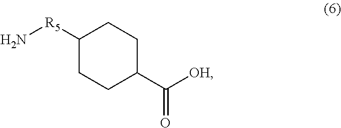

where R₅ is a C₁ to C₃ alkyl group, preferably a Cl alkyl group. Preferably, the C₈ to C₁₀ cycloaliphatic amino acid containing a cyclohexyl group is 4-aminomethylcyclohexanecarboxylic acid (“4-AMCC”). Of course, the cycloaliphatic amino acid according to formula (6) can be in a cis or trans conformation. Accordingly, the amino acid component (C) can include only the cis isomers, only the trans isomers or a mixture of the cis and the trans isomers.

In some embodiments, the concentration of the a C₈ to C₁₀ cycloaliphatic amino acid containing a cyclohexyl group is from 1 mol % to 9 mol %, preferably from 3 mol % to 9 mol %. In some embodiments, the reaction mixture (RM) is free of the C₈ to C₁₀ cycloaliphatic amino acid containing a cyclohexyl group. In some such embodiments, the amino acid component (C) may or may not contain additional amino acids distinct from the C₈ to C₁₀ cycloaliphatic amino acid containing a cyclohexyl group. In some embodiments, reaction mixture (RM) is free of amino acids.

In some embodiments, the total concentration of the C₈ to C₁₀ cycloaliphatic amino acid containing a cyclohexyl group is at least 90 mol %, at least 95 mol %, at least 98 mol %, at least 99 mol %, at least 99.5 mol % or at least 99.9 mol % relative to the total amount of amino acids in the amino acid component (C). In some embodiments, the amino acid component (C) can include additional amino acids, each distinct from each other and from the C₈ to C₁₀ cycloaliphatic amino acid. In some such embodiments including additional amino acids, the total concentration of C₈ to C₁₀ cycloaliphatic amino acids containing a cyclohexyl group is within the corresponding ranges given above. In other such embodiments including additional amino acids, the concentration of each additional C₈ to C₁₀ cycloaliphatic amino acid is distinct from the range given above with respect to the C₈ to C₁₀ cycloaliphatic amino acid containing a cyclohexyl group.

### Polyamide (PA) Synthesis

The polyamide (PA) described herein can be prepared by any conventional method adapted to the synthesis of polyamides and polyphthalamides. Preferably, the polyamide (PA) is prepared by reacting (by heating) the monomers in presence of less than 60 wt. % of water, preferentially less than 50 wt. %, up to a temperature of at least

Tm+10° C., Tm being the melting temperature of the polyamide (PA), where wt. % is relative to the total weight of the reaction mixture (RM).

The polyamide (PA) described herein can for example be prepared by thermal polycondensation (also referred to as polycondensation or condensation) of aqueous solution of monomers and comonomers. In one embodiment, the polyamide (PA) is formed by reacting, in the reaction mixture (RM), the diamines, the dicarboxylic acids and the amino acids. In some embodiments, the total number of moles of diamines in the diamine component (A) is substantially equimolar to the total number of moles of dicarboxylic acids in the dicarboxylic acid component (B). As used herein, substantial equimolar denotes a value that is +15% of the indicated number of moles. For example, in the context of the diamine and dicarboxylic acid concentrations in the respective diamine component (A) and dicarboxylic acid component (B) of the reaction mixture (RM), total number of moles of diamines in the diamine component (A) is +15% of the total number of moles of dicarboxylic acids in the dicarboxylic acid component (B). Significantly, as mentioned above, in the reaction mixture (RM) the total concentration of diamines, dicarboxylic acids and amino acids is selected such that [—NH₂]/[—COOH] is from 0.9 to 1.1, preferably from 0.95 to 1.05. The polyamides (PA) may contain a chain limiter, which is a monofunctional molecule capable of reacting with the amine or carboxylic acid moiety, and is used to control the molecular weight of the polyamide (PA). For example, the chain limiter can be acetic acid, propionic acid, benzoic acid and/or benzylamine. A catalyst can also be used. Examples of catalyst are phosphorous acid, ortho-phosphoric acid, meta-phosphoric acid, alkali-metal hypophosphite such as sodium hypophosphite and phenylphosphinic acid. A stabilizer, such as a phosphite, may also be used.

### The Polyamide (PA)

The polyamides (PA) include 3 recurring units (R_{PA1}) to (R_{PA3}), formed from the polycondensation of the diamines in the diamine component (A), the dicarboxylic acids in the dicarboxylic acid component (B) and the amino acids, if present, in the amino acid component (C). Of course, the polyamide (PA) can have additional recurring units, distinct from recurring units (R_{PA1}) to (R_{PA3}).

In some embodiments, recurring units (R_{PA1}) and (R_{PA2}) are represented by the following formulae, respectively:

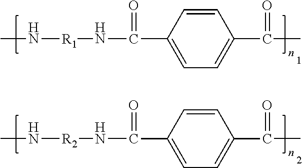

and recurring unit (R_{PA3}) is represented by either one of the following formulae:

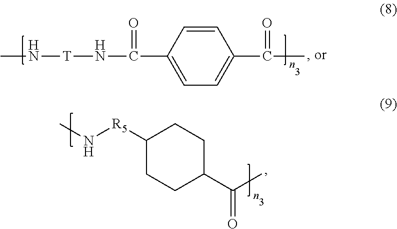

where R₁, R₂ and R₅ are defined above; n₁ to n₃ are mol % of recurring units (R_{PA1}) to (R_{PA3}), respectively; and T is represented by either one of the following formulae:

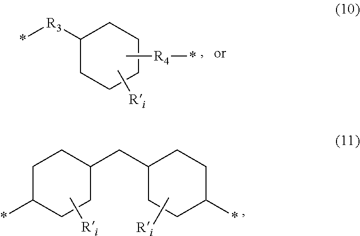

where R₃, R₄, R′ and i are defined above; and the ‘*’ denotes a bond to one of the two explicit nitrogen atoms in Formula (8). Preferably, T is represented by Formula (10), preferably where the —R₄-group is in meta (1,3-) position relative to the —R₃-group. Additionally or alternatively, in some embodiments, each i is zero. In one embodiment, recurring units (R_{PA1}) and (R_{PA2}) are formed from the polycondensation of HMDA and 1,10-diaminodecane with terephthalic acid. In one such embodiment, recurring unit (R_{PA3}) is formed form the polycondensation of either 1,3-BAC or 1,4-BAC, preferably 1,3-BAC, with terephthalic acid. In another such embodiment, recurring unit (R_{PA3}) is formed form the polycondensation of 4-AMCC. Preferably, n₁+n₂+n₃ is at least 50 mol %, at least 60 mol. %, at least 70 mol %, at least 80 mol %, at least 90 mol %, at least 95 mol %, or at least 99 mol %. As used herein, concentration of recurring units refers to the concentration relative to the total number of recurring unit is the polyamide (PA), unless explicitly stated otherwise. For example, with respect to recurring units (R_{PA1}) to (R_{PA3}) described above, n₁+n₂+n_{3≤100} mol %.

In some embodiments, the polyamide (PA) includes 4 recurring units: recurring units (R_{PA1}) and (R_{PA2}), as given above, and recurring units (R_{PA3}) and (R_{PA4}) represented by the following formulae, respectively:

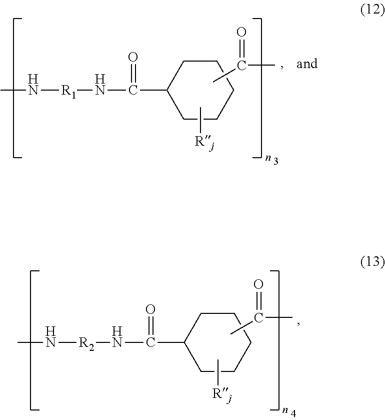

where R₁, R₂, R″, and j are defined above and where n₁ to n₄ are mol % of recurring units (R_{PA1}) to (R_{PA4}), respectively (n₁₊₂+n₃+n_{4≤100} mol %). Preferably, in each of Formulae (12) and (13), the explicit-COO— groups about the cyclohexyl ring are relatively positioned in the para (1,4-) position. Additionally or alternatively, in some embodiments, j is zero. In one embodiment, recurring units (R_{PA1}) and (R_{PA2}) are formed from the polycondensation of HMDA and 1,10-diaminodecane with terephthalic acid and recurring units (R_{PA3}) and (R_{PA4}) are formed form the polycondensation of HMDA and 1,10-diaminodecane with 1,4-CHDA. Preferably, n₁+n₂+n₃+n₄ is at least 50 mol %, at least 60 mol. %, at least 70 mol %, at least 80 mol %, at least 90 mol %, at least 95 mol %, or at least 99 mol %.

In some embodiments, the polyamides (PA) has a number average molecular weight Mn of from 1,000 g/mol to 40,000 g/mol, from 2,000 g/mol to 35,000 g/mol, from 4,000 to 30,000 g/mol, or from 5,000 g/mol to 20,000 g/mol. The number average molecular weight Mn can be determined by gel permeation chromatography (GPC) using ASTM D5296 with polystyrene standards.

The polyamide (PA) is semi-crystalline. As used herein, a semi-crystalline polyamide comprises a heat of fusion (“ΔH_{f}”) of at least 5 joules per gram (J/g) at a heating rate of 20° C./min. Similarly, as used herein, an amorphous polyamide comprises a ΔH_{f} of less than 5 J/g at a heating rate of 20C/min. ΔH_{f} can be measured according to ASTM D3418. In some embodiments, the ΔH_{f} is at least 20 J/g, at least 30 J/g or at least 40 J/g.

In some embodiments, the polyamide (PA) has a Tg of at least 100° C., at least 110° C., or at least 115° C. Additionally or alternatively, in some embodiment, the polyamide (PA) has a Tg of no more than 200° C., no more than 180° C., no more than 160° C., no more than 150° C., no more than 140° C., or no more than 135° C. In some embodiments, the polyamide (PA) has a Tg of from 100° C. to 150° C., from 110° C. to 140° C., or from 115° C. to 135° C. In some embodiments, the polyamide (PA) has a Tg of from 100° C. to 200° C., from 110° C. to 180° C., or from 115° C. to 160° C. In some embodiments, the polyamide (PA) has a melting temperature (“Tm”) of at least 290° C., at least 300° C., or at least 310° C. Additionally or alternatively, in some embodiments, the polyamide (PA) has a Tm of no more than 360° C., no more than 350° C., or no more than 340° C. In some embodiments the polyamide (PA) has a Tm of from 290° C. to 360° C., from 300° C. to 350° C., or from 310° C. to 340° C. Tg and Tm can be measured according to ASTM D3418.

### Polymer Composition (PC)

The polymer composition (PC) includes the polyamide (PA). The polyamide (PA) may be present in the polymer composition (PC) in a total amount of greater than 30 wt. %, greater than 35 wt. % by weight, greater than 40 wt. % or greater than 45 wt. %, based on the total weight of the polymer composition (PC). The polyamide (PA) may be present in the composition (PC) in a total amount of less than 99.95 wt. %, less than 99 wt. %, less than 95 wt. %, less than 90 wt. %, less than 80 wt. %, less than 70 wt. % or less than 60 wt. %, based on the total weight of the polymer composition (PC). The polyamide (PA) may, for example, be present in the polymer composition (PC) in an amount ranging between 35 and 60 wt. %, for example between 40 and 55 wt. %, based on the total weight of the polymer composition (PC).

The polymer composition (PC) may also comprise one component selected from the group consisting of reinforcing agents, tougheners, plasticizers, colorants, pigments, antistatic agents, dyes, lubricants, thermal stabilizers, light stabilizers, flame retardants, halogen free flame retardants, nucleating agents and antioxidants. Preferably, the polymer composition (PC) includes at least a halogen free flame retardant, reinforcing agents (e.g. glass fibers), or both.

A large selection of reinforcing agents, also called reinforcing fibers or fillers, may be added to the composition according to the present invention. They can be selected from fibrous and particulate reinforcing agents. A fibrous reinforcing filler is considered herein to be a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50. In some embodiments, the reinforcing fibers (e.g. glass fibers or carbon fibers) have an average length of from 3 mm to 50 mm. In some such embodiments, the reinforcing fibers have an average length of from 3 mm to 10 mm, from 3 mm to 8 mm, from 3 mm to 6 mm, or from 3 mm to 5 mm. In alternative embodiments, the reinforcing fibers have an average length of from 10 mm to 50 mm, from 10 mm to 45 mm, from 10 mm to 35 mm, from 10 mm to 30 mm, from 10 mm to 25 mm or from 15 mm to 25 mm. The average length of the reinforcing fibers can be taken as the average length of the reinforcing fibers prior to incorporation into the polymer composition (PC) or can be taken as the average length of the reinforcing fiber in the polymer composition (PC).

The reinforcing filler may be selected from mineral fillers (such as talc, mica, kaolin, calcium carbonate, calcium silicate, magnesium carbonate), glass fibers, carbon fibers, synthetic polymeric fibers, aramid fibers, aluminum fibers, titanium fibers, magnesium fibers, boron carbide fibers, rock wool fibers, steel fibers and wollastonite.

Among fibrous fillers, glass fibers are preferred; they include chopped strand A-, E-, C-, D-, S- and R-glass fibers, as described in chapter 5.2.3, p. 43 48 of Additives for Plastics Handbook, 2nd edition, John Murphy. Preferably, the filler is chosen from fibrous fillers. It is more preferably a reinforcing fiber that is able to withstand the high temperature applications.

The reinforcing agents may be present in the composition (PC) in a total amount of greater than 15 wt. %, greater than 20 wt. % by weight, greater than 25 wt. % or greater than 30 wt. %, based on the total weight of the polymer composition (PC). The reinforcing agents may be present in the polymer composition (PC) in a total amount of less than 65 wt. %, less than 60 wt. %, less than 55 wt. % or less than 50 wt. %, based on the total weight of the polymer composition (PC). The reinforcing filler may for example be present in the polymer composition (PC) in an amount ranging between 20 and 60 wt. %, for example between 30 and 50 wt. %, based on the total weight of the polymer composition (PC).

The polymer composition (PC) may also comprise a toughener. A toughener is generally a low glass transition temperature (Tg) polymer, with a Tg for example below room temperature, below 0° C. or even below −25° C. As a result of its low Tg, the toughener are typically elastomeric at room temperature. Tougheners can be functionalized polymer backbones. The polymer backbone of the toughener can be selected from elastomeric backbones comprising polyethylenes and copolymers thereof, e.g. ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

When the toughener is functionalized, the functionalization of the backbone can result from the copolymerization of monomers which include the functionalization or from the grafting of the polymer backbone with a further component. Specific examples of functionalized tougheners include, but are not limited to, terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride.

The toughener may be present in the polymer composition (PC) in a total amount of greater than 1 wt. %, greater than 2 wt. % or greater than 3 wt. %, based on the total weight of the polymer composition (PC). The toughener may be present in the polymer composition (PC) in a total amount of less than 30 wt. %, less than 20 wt. %, less than 15 wt. % or less than 10 wt. %, based on the total weight of the polymer composition (PC).

The polymer composition (PC) may also comprise other conventional additives commonly used in the art, including plasticizers, colorants, pigments (e.g. black pigments such as carbon black and nigrosine), antistatic agents, dyes, lubricants (e.g. linear low density polyethylene, calcium or magnesium stearate or sodium montanate), thermal stabilizers, light stabilizers, flame retardants, nucleating agents and antioxidants.

The polymer composition (PC) may also comprise one or more other polymers, preferably polyamides different from the polyamide (PA) of the present invention. Mention can be made notably of semi-crystalline or amorphous polyamides, such as aliphatic polyamides, semi-aromatic polyamides, and more generally the polyamides obtained by polycondensation between an aromatic or aliphatic saturated diacid and an aliphatic saturated or aromatic primary diamine, a lactam, an amino-acid or a mixture of these different monomers.

### Preparation of the Polymer Composition (PC)

The invention further pertains to a method of making the polymer composition (PC) as above detailed, said method comprising melt-blending the polyamide (PA) and the specific components, e.g. a filler, a toughener, a stabilizer, and of any other optional additives.

Any melt-blending method may be used for mixing polymeric ingredients and non-polymeric ingredients in the context of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing agent presents a long physical shape (for example, a long glass fiber), drawing extrusion molding may be used to prepare a reinforced composition.

### Articles and Applications

The polyamide (PA) and polymer composition (PC) can be desirably incorporated into articles.

The article can notably be used in mobile electronics, LED packaging, oil and gas components, food contact components (including, but not limited to, food film and casing), electrical and electronic components (including, but not limited to, power unit components for computing, data-system and office equipment and surface mounted technology compatible connectors and contacts), medical device components, construction components (including, but not limited to, pipes, connectors, manifolds and valves, for cooling and heating systems; boiler and meter components; gas systems pipes and fittings; and electrical protection devices for mini-circuit breakers, contactors, switches and sockets), industrial components, plumbing components (including, but not limited to, pipes, valves, fittings, manifolds, shower taps and shower valves), automotive components, and aerospace components (including, but not limited to, interior cabin components).

The article can be, for example, a mobile electronic device component. As used herein, a “mobile electronic device” refers to an electronic device that is intended to be conveniently transported and used in various locations. A mobile electronic device can include, but is not limited to, a mobile phone, a personal digital assistant (“PDA”), a laptop computer, a tablet computer, a wearable computing device (e.g., a smart watch, smart glasses and the like), a camera, a portable audio player, a portable radio, global position system receivers, and portable game consoles.

The mobile electronic device component may include, for example, a radio antenna and the composition (C). In this case, the radio antenna can be a WiFi antenna or an RFID antenna. The mobile electronic device component may also be an antenna housing.

In some embodiments, the mobile electronic device component is an antenna housing. In some such embodiments, at least a portion of the radio antenna is disposed on the polymer composition (PC). Additionally or alternatively, at least a portion of the radio antenna can be displaced from the polymer composition (PC). In some embodiments, the device component can be of a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a switch, or a switchpad. In some embodiments, the mobile electronic device can be at least a portion of an input device.

Examples of electric and electronics devices are connectors, contactors and switches.

The polyamide (PA) or polymer composition (PC) and articles prepared therefrom may also be used as a gas barrier material for packaging applications, in mono or multilayer articles.

Examples of oil and gas components include, but are not limited to, compressor rings, poppets, back-up seal rings, electrical connectors, labyrinth seals, motor end plates, bearings, bushings, suck rod guides and down hole tubing.

Examples of automotive components include, but are not limited to, components in thermal management systems (including, but not limited to, thermostat housings, water inlet/outlet valves, water pumps, water pump impellers, and heater cores and end caps), air management system components (including, but not limited to, turbocharger actuators, turbocharger by-pass valves, turbocharger hoses, EGR valves, CAC housings, exhaust gas recirculation systems, electronic controlled throttle valves, and hot air ducts), transmission components and launch device components (including, but not limited to, dual clutch transmissions, automated manual transmissions, continuously variable transmissions, automatic transmissions, torque convertors, dual mass flywheels, power takeoffs, clutch cylinders, seal rings, thrust washers, thrust bearings, needle bearings, and check balls), automotive electronic components, automotive lighting components (including, but not limited to, motor end caps, sensors, ECU housings, bobbins and solenoids, connectors, circuit protection/relays, actuator housings, Li-Ion battery systems, and fuse boxes), traction motor and power electronic components (including, but not limited to, battery packs), fuel and selective catalytic reduction (“SCR”) systems (including, but not limited to, SCR module housings and connectors, SCR module housings and connectors, fuel flanges, rollover valves, quick connects, filter housings, fuel rails, fuel delivery modules, fuel hoses, fuel pumps, fuel injector o-rings, and fuel hoses), fluid system components (e.g. fuels system components) (including, but not limited to inlet and outlet valves and fluid pump components), interior components (e.g. dashboard components, display components, and seating components), and structural and lightweighting components (e.g. gears and bearings, sunroofs, brackets and mounts, electrical battery housings, thermal management components, braking system elements, and pump and EGR systems).

The article can be molded from the polyamide (PA) or polymer composition (PC) by any process adapted to thermoplastics, e.g. extrusion, injection molding, blow molding, rotomolding or compression molding.

The article can be printed from the polyamide (PA) or polymer composition (PC) by a process comprising a step of extrusion of the material, which is for example in the form of a filament, or comprising a step of laser sintering of the material, which is in this case in the form of a powder.

In some embodiments, the polyamide (PA) or polymer composition (PC) can be desirably incorporated into three dimensional printing applications. One application is direct to a method for manufacturing a three-dimensional (“3D”) object with an additive manufacturing system, comprising providing a part material comprising the polyamide (PA) or polymer composition (PC) of the present invention, and printing layers of the three-dimensional object from the part material.

The polyamide (PA) or polymer composition (PC) can therefore be in the form of a thread or a filament to be used in a process of 3D printing, e.g. Fused Filament Fabrication, also known as Fused Deposition Modelling (“FDM”).

The polyamide (PA) or polymer composition (PC) can also be in the form of a powder, for example a substantially spherical powder, to be used in a process of 3D printing, e.g. Selective Laser Sintering (SLS).

The polyamide (PA) or polymer composition (PC) can be incorporated into a composite. A composite includes continuous reinforcing fibers imbedded in a thermoplastic matrix. In some embodiments, tne continuous reinforcing fiber is selected from glass fiber, carbon fibers, aluminum fiber, titanium fiber, magnesium fiber, boron carbide fibers, rock wool fiber, steel fiber, aramid fiber, natural fiber (e.g. cotton, linen and wood) and any combination of one or more, thereof. Preferably, the continuous reinforcing fiber is glass fiber or carbon fiber. As used herein, continuous reinforcing fibers are reinforcing fibers that have an average length in the longest dimension of at least 5 millimeters (“mm”), at least 10 mm, at least 25 mm or at least 50 mm. The thermoplastic matrix includes the polyamide (PA) or polymer composition (PC). The composite can be a unidirectional composite (e.g. a tape) or a multidirectional composite (e.g. a woven fabric, a mat, or a layered fabric).

### Use of the Polyamides (PA), Polymer Compositions (PC) and Articles

In some embodiments, the polyamides (PA), polymer compositions (PC) or articles can be used for manufacturing a mobile electronic device component, as described above.

The polyamides (PA) or polymer compositions (PC) can also be used for 3D printing an object.

### Examples

These examples demonstrate the thermal and moisture absorption performance the polyamides (PA). As used in the Examples, “E” denotes an example embodiment of the present invention and “CE” denotes a counter example.

### Raw Materials

HMDA: obtained from Ascend Performance Materials (70%)
1,10-diaminodecane (“DMDA”): obtained from Solvay (Novecare)
1,3-BAC: obtained from Mitsubishi Gas Chemical Company
Terephthalic Acid (“TA”): obtained from Flint Hills Resources
Isophthalic Acid (“IA”): obtained from Flint Hills Resources
Adipic Acid (“AA”): obtained from Invista
1,4-CHDA: obtained from Eastman Chemical Company
4-AMCC: obtained from Sigma-Aldrich
PA 6,T/6,6 65/35: obtained from Solvay Specialty Polymers USA, L.L.C.
PA10,T/10,I: Obtained from Kingfa (Vicnyl® 6100)
PA9,T: Obtained from Kuraray (Genestar™ GC 61210)
Impact Modifier: Obtained from Kraton Corporation (Kraton™ FG1901 GT; linear triblock copolymer based on styrene and ethylene/butylene with a polystyrene content of 30%)
Glass Fiber: Chopped E-glass Fiber (NEG HP 3610 from Nippon Electric Glass Co.)
Additive Package: Consisted of mold release, antioxidant and talc.

### Example 1-Synthesis of Polyamides and Polymer Compositions

This example demonstrates the synthesis of the polyamides.

All of the copolyamides shown in Table 1 were prepared according to the following similar process using a 1-gallon autoclave reactor equipped with a distillate line fitted with a pressure control valve. As an example, in the preparation of copolyamide E1, the reactor was charged with 283g of DI water, 173g of hexamethylenediamine (70%), 116g of 1,10-diaminodecane, 242g of terephthalic acid, 22g of 1,-4-cyclohexanedicarboxylic acid, 1.9g of acetic acid and 0.16g of phosphorus acid. The reactor was sealed, purged with nitrogen and heated to 260° C. The steam generated was slowly released to keep the internal pressure at 120 psig. The temperature was increased to 320° C. The reaction mixture was kept at 320° C. and the reactor pressure was reduced to atmospheric. After holding for an additional 60 min, the polymer was discharged from the reactor.

The following process was also used to prepare larger quantities of copolyamides analogously to following method for the preparation of E1: A stirred batch vessel was charged with 33.7 kg deionized water; a diamine component consisting of 21.58 kg of 70% hexamethylenediamine, 14.47 kg of 1,10-diaminodecane; and a dicarboxylic acid component consisting of 30.11 kg of terephthalic acid and 2.71 kg of 1,4-cyclohexanedicarboxylic acid. The reactor was also charged with 17.03g phosphorus acid and 360.30g of glacial acetic acid. A salt solution was obtained by heating the above described mixture at 150° C. The contents were pumped continuously to a reactor zone maintained at about 180 psig and 220° C., then to a high pressure zone maintained at 300C and then through a tubular reactor at 100 psig heated to 350C. The melt was fed into a twin-screw extruder equipped with a forward vacuum vent. The finished polymer was extruded through a strand die into a water bath and chopped into pellets.

Sample parameters are shown in Table 1. For clarity, in the “Polyamide” column of Table 1, numeric prefixes are suppressed. For example, 1,3-BAC is referred to as BAC in the “Polyamide” column in Table 1.

TABLE 1

| | Reaction Mixture (RM) | | | | | | | | |
|---|---|---|---|---|---|---|---|---|---|
| | | | | Dicarboxylic Acid | | | | Amino | |
| | Diamine Component | | | Component (B) | | | | Acid | Polyamide |
| | (A) | | | (mol %) | | | | Component | Recurring Units in |
| | (mol %) | | | | | | 1,4- | (C) (mol %) | the Polyamide |
| Example | HMDA | DMDA | 1,3-BAC | TA | IA | AA | CHDA | 4-AMCC | (PA) |
| CE1 | 65 | 35 | | 80 | | | 20 | | 6, T/10, T/6, |
| | | | | | | | | | CHDA/10, CHDA |
| E1 | 65 | 35 | | 92 | | | 8 | | 6, T/10, T/6, |
| | | | | | | | | | CHDA/10, CHDA |
| CE2 | 65 | 35 | | 100 | | | | | 6, T/10, T |
| E3 | 65 | 35 | | 100 | | | | 5 | 6, T/10, T/AMCC |
| CE3 | 65 | 35 | | 92 | 8 | | | | 6, T/10, T/6, I/10, I |
| E4 | 60 | 35 | 5 | 100 | | | | | 6, T/10, T/BAC, T |
| CE4 | 100 | | | 70 | 30 | | | | 6, T/6, I |
| CE5 | 100 | | | 55 | | 45 | | | 6, T/6, 6 |
| CE6 | 100 | | | 65 | 25 | 10 | | | 6, T/6, I/6, 6 |
| CE7 | 65 | 35 | | 95 | 5 | | | | 6, T/10, T/6, I/10, I |
| E5 | 57 | 35 | 8 | 100 | | | | | 6, T/10, T/BAC, T |

Additionally, polymer compositions were formed from the polymers in Table 1, as well as other polyamides, to demonstrate mechanical performance. Sample parameters are shown in Table 1A (all values are in wt. %). The polyamide E5 used in the compositions has an Inherent Viscosity (IV) of 1.15 dL/g as measured according to ASTM D5225.

TABLE 1A

| Example | E6 | E7 | CE8 | CE9 | CE10 | CE11 |
|---|---|---|---|---|---|---|
| PA | 68.50 | 65.40 | | | | |
| 6, T/10, T/BAC, T | | | | | | |
| (E5) | | | | | | |
| PA 6, T/6, 6 65/35 | | | 68.50 | 65.40 | | |
| PA 10, T/10, I | | | | | 68.50 | |
| PA 9, T | | | | | | 68.50 |
| Impact Modifier | | 3.10 | | 3.10 | | |
| Additive Package | 1.5 | 1.5 | 1.5 | 1.5 | 1.5 | 1.5 |
| Glass Fiber | 30 | 30 | 30 | 30 | 30 | 30 |

### Example 2: Thermal Performance

To demonstrate thermal performance, Tm, Tg, Tc, enthalpy of melting (“Hm”) and enthalpy of crystallization (“Hc”) were measured. Tm and Tg were measured as described above. Tc, Hm and Hc were measured according to ASTM D3418. Water absorption for the neat resins (see Table 2) were measured as follows: Discs with 2 inches diameter and ⅛ inch thickness were molded. The disc samples were placed in boiling water and their weights were monitored regularly until they became constant. The percent water absorption was calculated as ((weight final-weight initial)×100)/(weight initial). The water absorption reported in Table 2A was measured according to ASTM D570.

TABLE 2

| | | | | | | Water |
|---|---|---|---|---|---|---|
| | Tg | Tm | Hm | Tc | Hc | Absorption |
| Example | (° C.) | (° C.) | (J/g) | (° C.) | (J/g) | (%) |
| CE1 | 123 | 312 | 53 | 273 | 45 | 4.0 |
| E1 | 128 | 321 | 50 | 276 | 48 | 3.9 |
| CE2 | 123 | 322 | 68 | 289 | 55 | 3.7 |
| E3 | 130 | 321 | 52 | 272 | 55 | 4.0 |
| CE3 | 119 | 318 | 55 | 275 | 49 | 4.1 |
| E4 | 130 | 320 | 60 | 268 | 54 | 4.9 |
| CE4 | 137 | 320 | 50 | 267 | 51 | 6.0 |
| CE5 | 105 | 325 | 68 | 287 | 54 | 7.0 |
| CE6 | 125 | 309 | 53 | 253 | 43 | 6.2 |
| CE7 | 123 | 319 | 78 | 289 | 62 | 3.9 |

TABLE 2A

| | Tg | Tm | Water Absorption |
|---|---|---|---|
| Example | (° C.) | (° C.) | (%) |
| E5 | 132 | 315 | 0.24 |
| E6 | 132 | 315 | 0.23 |
| CE8 | 100 | 325 | 0.32 |
| CE9 | 100 | 325 | 0.33 |
| CE10 | 110 | 292 | 0.15 |
| CE11 | 110 | 307 | 0.14 |

Referring to Table 2, comparison CE1, CE2 and E1 demonstrates that, surprisingly, introducing a relatively small amount of 1,4-CHDA (8 mol %) into PA 6T/10T significantly increases the Tg (5° C.), while maintaining a high Tm and Tc. On the other hand, introducing larger amounts of 1,4-CHDA (20 mol %) decreases both the Tg and Tm, relative to PA 6T/10T. Furthermore, comparison CE2 and E3 shows that a small amount of 4-AMCC significantly increases the Tg (7° C.) of a PA 6T/10T copolymer, while maintaining a high Tm and Tc. Comparison of CE2 and E4 shows that a relatively small amount of 1,3-BAC (5 mol %) significantly increases the Tg (7° C.) of a PA 6T/10T copolymer while maintaining a high Tg and Tc.

Unlike examples E1, E3, E4 that contain a small amount of cycloaliphatic monomer containing monomer containing a cyclohexyl group, the addition of a small amount of an aromatic containing diacid such as isophthalic acid (CE3), usually expected more rigid, decreases Tg (4° C.) and Tm.

### Example 3: Mechanical Performance

To demonstrate mechanical performance, tensile stress, tensile strain, weld tensile stress and weld tensile strain were measured according to ISO 527. The mechanical properties were measured on sample injection molded with one gate (“normal”) and two gates (“weld”) to assess the effect of the weld-line. Results are displayed in Table 3.

TABLE 3

| Example | E6 | E7 | CE8 | CE9 | CE10 | CE11 |
|---|---|---|---|---|---|---|
| Tensile Stress- | 214 | 202 | 197 | 208 | 194 | 181 |
| “normal” | | | | | | |
| (MPa) | | | | | | |
| Tensile Strain- | 2.90 | 3.00 | 2.00 | 2.60 | 2.50 | 2.20 |
| “normal” | | | | | | |
| (%) | | | | | | |
| Weld Tensile | 87.1 | 111.0 | 58.4 | 80.3 | 60.6 | 50.7 |
| Stress-“weld” | | | | | | |
| (MPa) | | | | | | |
| Weld Tensile | 1.20 | 1.60 | 0.67 | 1.00 | 0.87 | 0.70 |
| Strain-“weld” | | | | | | |
| (%) | | | | | | |

Referring to Table 3, E6 and E7 generally had improved mechanical properties, relative to examples CE8 to CE11. While the resin E5 used in composition E6 is composed of a lower content of flexible long chain diamine than the resins of composition CE10 and CE11, composition E6 has a higher strength and exhibits surprisingly a higher elongation and weld line strength compared to compositions CE10 and CE11. These improved mechanical properties are kept when an elastomer is introduced in composition E7.

The embodiments above are intended to be illustrative and not limiting. Additional embodiments are within the inventive concepts. In addition, although the present invention is described with reference to particular embodiments, those skilled in the art will recognized that changes can be made in form and detail without departing from the spirit and scope of the invention. Any incorporation by reference of documents above is limited such that no subject matter is incorporated that is contrary to the explicit disclosure herein.

1. A polyamide (PA) formed from the polycondensation of a reaction mixture (RM) comprising:
a diamine component (A) comprising:
55 mol % to 75 mol % of a C₄ to C₈ aliphatic diamine,
25 mol % to 45 mol % of a C₉ to C₁₂ aliphatic diamine, and
0 mol % to 10 mol % of a cycloaliphatic diamine containing a cyclohexyl group,
wherein mol % is relative to the total number of moles of diamines in the diamine component (A);
a dicarboxylic acid component (B) comprising:
90 mol % to 100 mol % of terephthalic acid,
0 mol % to 10 mol % of a C₆ to C₁₈ aliphatic dicarboxylic acid or an C₈ to C₁₈ aromatic dicarboxylic acid distinct from terephthalic acid, and
0 mol % to 10 mol % of a cycloaliphatic dicarboxylic acid containing a cyclohexyl group,
wherein mol % is relative to the total number of moles of dicarboxylic acids in the dicarboxylic acid component (B) and
an amino acid component (C) comprising:
0 mol % to 9 mol % of a C₈ to C₁₀ cycloaliphatic amino acid containing a cyclohexyl group,
wherein mol % is relative to the total number of moles of dicarboxylic acids in the dicarboxylic acid component (B); and
wherein one of the cycloaliphatic diamine, the cycloaliphatic dicarboxylic acid, and the cycloaliphatic amino acid has a concentration of greater than 0.5 mol %.

2. The polyamide (PA) of claim 1, wherein the C₄ to C₈ aliphatic diamine is selected from the group consisting of 1,4-diaminobutane (“putrescine”), 1,5-diaminopentane (“cadaverine”), 2-methyl-1,5-diaminopentane, hexamethylenediamine 3-(“HMDA”), methylhexamethylenediamine, 2,5-dimethylhexamethylenediamine, 1,7-diaminoheptane and 1,8-diaminooctane, preferably the C₄ to C₈ aliphatic diamine is HMDA.

3. The polyamide (PA) of either claim 1 or 2, wherein the C₉ to C₁₂ aliphatic diamine is selected from the group consisting of 2,2,4-trimethyl-hexamethylenediamine, 2,4,4-trimethyl-hexamethylenediamine, 2-ethyl-1,7-diaminoheptane, 2-methyl-1,8-diaminooctane, 2,2,7,7-tetramethyloctamethylenediamine, 1,9-diaminononane, 2-methyl-1,8-diaminooctane, 5-methyl-1,9-diaminononane, 1,10-diaminodecane, 1,11-diaminoundecane, and 1,12-diaminododecane, preferably the C₉ to C₁₂ aliphatic diamine is 1,10-diaminodecane.

4. The polyamide (PA) of any one of claims 1 to 3, wherein the C₆ to C₁₈ aliphatic dicarboxylic acid is selected from the group consisting of 2,2-dimethyl-glutaric acid, adipic acid, 2,4,4-trimethyl-adipic acid, pimelic acid, suberic acid, azelaic acid, sebacic acid, undecanedioic acid, dodecanedioic acid, tridecanedioic acid, tetradecanedioic acid, pentadecanedioic acid, hexadecanedioic acid, and octadecanedioic acid, preferably, the C₆ to C₁₈ aliphatic dicarboxylic acid is selected from adipic acid and sebacic acid, most preferably adipic acid.

5. The polyamide (PA) of any one of claims 1 to 4, wherein the C₈ to C₁₈ aromatic dicarboxylic acid distinct from terephthalic acid is selected from the group consisting of isophthalic acid, naphthalenedicarboxylic acid, 4,4′-bibenzoic acid, 2,5-pyridinedicarboxylic acid, 2,4-pyridinedicarboxylic acid, 3,5-pyridinedicarboxylic acid, 2,2-bis(4-carboxyphenyl) propane, 2,2-bis(4-carboxyphenyl) hexafluoropropane, 2,2-bis(4-carboxyphenyl) ketone, 4,4′-bis(4-carboxyphenyl) sulfone, 2,2-bis(3-carboxyphenyl) propane, 2,2-bis(3-carboxyphenyl) hexafluoropropane, 2,2-bis(3-carboxyphenyl) ketone, bis(3-carboxyphenoxy)benzene, preferably the C₈ to C₁₈ aromatic dicarboxylic acid is naphthalenedicarboxylic acid or 4,4′-bibenzoic acid.

6. The polyamide (PA) of any one of claims 1 to 5, wherein the cycloaliphatic dicarboxylic acid containing a cyclohexyl group is represented by the following formula: 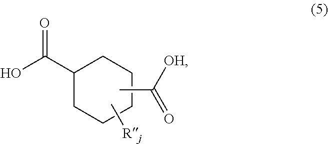
wherein
R″, at each location, is independently selected from the group consisting of an alkyl, an aryl, an alkali or alkaline earth metal sulfonate, an alkyl sulfonate, and a quaternary ammonium; and
j is an integer from 0 to 10.

7. The polyamide (PA) of any one of claims 1 to 6, wherein the C₈ to C₁₀ cycloaliphatic amino acid containing a cyclohexyl group is represented by the following formula: 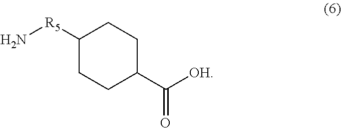
wherein
R₅ is a C₁ to C₃ alkyl group.

8. The polyamide (PA) of any one of claims 1 to 7, wherein the C₈ to C₁₀ cycloaliphatic amino acid containing a cyclohexyl group is 1,4 aminomethylcyclohexanecarboxylic acid (“4-AMCC”).

9. The polyamide (PA) of any one of claims 1 to 8 wherein only one of the cycloaliphatic diamine, the cycloaliphatic dicarboxylic acid, and the cycloaliphatic amino acid has a concentration of greater than 0.5 mol %, preferably at least 1 mol %, and wherein the reaction mixture (RM) is free of the other two cycloaliphatic monomers containing a cyclohexyl group.

10. The polyamide (PA) of any one of claims 1 to 9, wherein the reaction mixture (RM) is free of the C₆ to C₁₈ aliphatic dicarboxylic acid or an C₈ to C₁₈ aromatic dicarboxylic acid distinct from terephthalic acid.

11. A polymer composition (PC), comprising:
the polyamide (PA) of any one of claims 1 to 10, and
at least one component selected from the group consisting of reinforcing agents, tougheners, plasticizers, colorants, pigments, antistatic agents, dyes, lubricants, thermal stabilizers, light stabilizers, flame retardants, halogen free flame retardants, nucleating agents and antioxidants, preferably at least a halogen free flame retardant.

12. The polymer composition (PC) of claim 11 or 12, comprising from 10 wt. % to 60 wt. % of glass fibers, based on the total weight of the polymer composition (PC).

13. The polymer composition (PC) of any one of claims 11 to 12, comprising from 30 wt. % to 70 wt. % of the polyamide (PA).
